(19) United States
(12) Patent Application Publication
(10) Pub. No.: US 2013/0174176 A1
(43) Pub. Date: Jul. 4, 2013

(54) WORKLOAD MANAGEMENT IN A DATA STORAGE SYSTEM

(71) Applicant: Haim KOPYLOVITZ, Herzliya (IL)

(72) Inventor: Haim KOPYLOVITZ, Herzliya (IL)

(73) Assignee: Infinidat Ltd., Herzliya (IL)

(21) Appl. No.: 13/343,208

(22) Filed: Jan. 4, 2012

(51) Int. Cl. G06F 9/46

(52) U.S. Cl. 718/105

(57) ABSTRACT

According to certain aspects, the presently disclosed subject matter includes a method, system and apparatus, for managing a plurality of disk drives in a storage system. The workload of at least one disk drive among the plurality of disk drives is monitored, wherein the monitoring comprises receiving data indicative of a temperature of the at least one disk drive. In case the measured temperature matches a predefined criterion, the modification of workload distribution across the plurality of disk drives is enabled, in order to reduce workload of the at least one disk drive.

### FIELD OF THE INVENTION

This invention relates to the field of management of data storage systems, and more specifically to balanced distribution of workload in a storage system.

### BACKGROUND OF THE INVENTION

One concern in storage system management is providing a balanced distribution of workload over the storage resources in a storage system. These resources are monitored in order to identify storage resources that are characterized by workload levels greater than a predefined threshold.

For example, supervising the ongoing functioning of disk drives in a storage system and identifying disk drives characterized by a high level of workload (referred to herein as “hot disk drives”), assists in managing the disk drive's regular operation, in order to prevent reaching overload of the disk drive, and for maintaining a balanced workload across multiple disk drives in a storage system.

Typical techniques for identifying hot disk drives include statistical measures that monitor the workload level in individual disk drives. For example, the task queue in each disk drive is monitored in order to identify long task queues, which may indicate high workload levels. According to other approaches, the rate of I/O workload in each disk is measured. For example, in case the measured rate of I/O per second (IOPS), I/O per logical volume or I/O per physical device is high, this may indicate high workload level of the disk drive.

The problem of load balancing of activities of data storage system has been recognized in the Prior Art and various method and systems have been developed to provide a solution, for example:

U.S. Pat. No. 6,766,416 discloses load balancing of activities on physical disk storage devices, by monitoring reading and writing operations to logical volumes on the physical disk storage devices. A list of exchangeable pairs of logical volumes is developed based on size and function. Statistics accumulated over an interval are then used to obtain access activity values for each logical volume and each physical disk drive. A statistical analysis selects one logical volume pair. After testing to determine any adverse effect of making that change, the exchange is made to more evenly distribute the loading on individual physical disk storage devices.

In modern storage systems, a temperature of disk drives is measured in order to indicate the disk drive's status. A disk drive's temperature, which is higher than a predefined threshold implies a hardware problem, which may result in disk drive failure. In order to prevent disk drive failure resulting from overheating, the system may decide to gracefully shut down the disk drive, if its temperature is higher than a predefined threshold.

U.S. Pat. No. 7,146,521 discloses a data storage system and method capable of reducing the operating temperature of the data storage system, removing any overheating storage devices from operation, reconstructing data, and evacuating data from the overheating storage devices before the devices and the data are damaged or lost.

U.S. Pat. No. 7,849,261 discloses a method and apparatus for reducing a likelihood of a cascade failure in a multi-device array. The array preferably comprises a controller and a plurality of storage devices to define a memory space across which data are stored in accordance with a selected RAID configuration. The controller operates to sever an operational connection between the storage devices and a host device in relation to a detected temperature of at least one storage device of the array. When a selected device reaches a first threshold temperature level, the controller arms for a potential shutdown. When a selected device reaches a second higher threshold temperature, the controller powers down all of the devices and executes a self-reboot operation. The controller monitors a temperature of the array while the devices remain powered down, after which the storage devices are powered up and data reconstruction operations take place as required.

### SUMMARY OF THE INVENTION

According to an aspect of the presently disclosed subject matter there is provided a storage system comprising a storage control layer operatively coupled to a plurality of disk drives, the storage control layer comprising at least one processor operable to receive data indicative of a temperature of at least one disk drive among the plurality of disk drives, wherein the temperature is indicative of workload of the at least one disk drive; and responsive to receiving a temperature matching a predefined criterion, to enable modification of workload distribution across the plurality of disk drives in order to reduce a workload of the at least one disk drive.

According to certain embodiments, the storage control layer is further operable to determine whether the data is indicative of a temperature matching the predefined criterion.

According to certain embodiments, the storage control layer is configured to facilitate the modification by migrating popular data from the at least one disk drive to at least one other disk drive, the at least one other disk drive having a temperature not matching the predefined criterion.

According to certain embodiments, the control layer is further configured to facilitate the modification by directing a read-request in respect of a first data located on the at least one disk drive to at least one other disk drive, the at least one other disk drive having a temperature not matching the predefined criterion and containing a second data which is sufficient for obtaining the first data.

According to certain embodiments, the control layer is further configured to facilitate the modification by redirecting a write-request to at least one other disk drive, the at least one other disk drive having a temperature not matching the predefined criterion.

According to a further aspect of the presently disclosed subject matter there is provided a method of managing a plurality of disk drives in a storage system, the method comprising: monitoring a workload of at least one disk drive among the plurality of disk drives, wherein the monitoring comprises receiving data indicative of a temperature of the at least one disk drive; and responsive to matching the temperature to a predefined criterion, enabling modification of workload distribution across the plurality of disk drives in order to reduce workload of the at least one disk drive.

According to certain embodiments of the presently disclosed subject matter, the method further comprising, determining whether the data is indicative of a temperature matching the predefined criterion.

According to certain embodiments of the presently disclosed subject matter, the enabling comprises directing a read-request in respect of a first data located on the at least one disk drive to at least one other disk drive, having a temperature not matching the predefined criterion and containing a second data which is sufficient for obtaining the first data.

According to certain embodiments of the presently disclosed subject matter, the enabling comprises redirecting a write-request to at least one other disk drive, having a temperature not matching the predefined criterion.

According to a further aspect of the presently disclosed subject matter there is provided a program storage device readable by machine, tangibly embodying a program of instructions executable by the machine to perform a method of managing a plurality of disk drives in a storage system, the method comprising monitoring a workload of at least one disk drive among the plurality of disk drives, wherein the monitoring comprises obtaining data indicative of a temperature of the at least one disk drive; determining whether the data indicative of a temperature matches the predefined criterion; and responsive to matching the temperature to a predefined criterion, enabling modification of workload distribution across the plurality of disk drives in order to reduce workload of the at least one disk drive.

According to yet a further aspect of the presently disclosed subject matter there is provided a workload management unit operatively connected to a storage control layer comprising at least one processor in storage system, the control layer being operatively coupled to a plurality of disk drives, the workload management unit operable to receive data indicative of a temperature of at least one disk drive among the plurality of disk drives, wherein the temperature is indicative of workload of the at least one disk drive; and responsive to the receiving a temperature matching a predefined criterion, to enable modification of workload distribution across the plurality of disk drives in order to reduce workload of the at least one disk drive.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a schematic functional block diagram of a virtualized storage system, in accordance with the presently disclosed subject matter; and

FIG. 2 illustrates a flowchart of operations performed, in accordance with the presently disclosed subject matter.

### DETAILED DESCRIPTION

Unless specifically stated otherwise, as apparent from the following discussions, it is appreciated that throughout the specification discussions utilizing terms such as determining, obtaining, matching, modifying, reducing, communicating, allocating, monitoring, measuring, or the like, refer to the action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

It should be noted that the term “criterion” as used herein should be expansively construed to include any compound criterion, including, for example, several criteria and/or their logical combinations.

In the following description, the teaching disclosed herein is described with relation to disk drives. However, it should be noted that disk drives represent a non-limiting example of “storage resources” and the same principles described herein with reference to disk drives are applicable to other types of storage resources such as enclosures, switches, memory sections, etc.

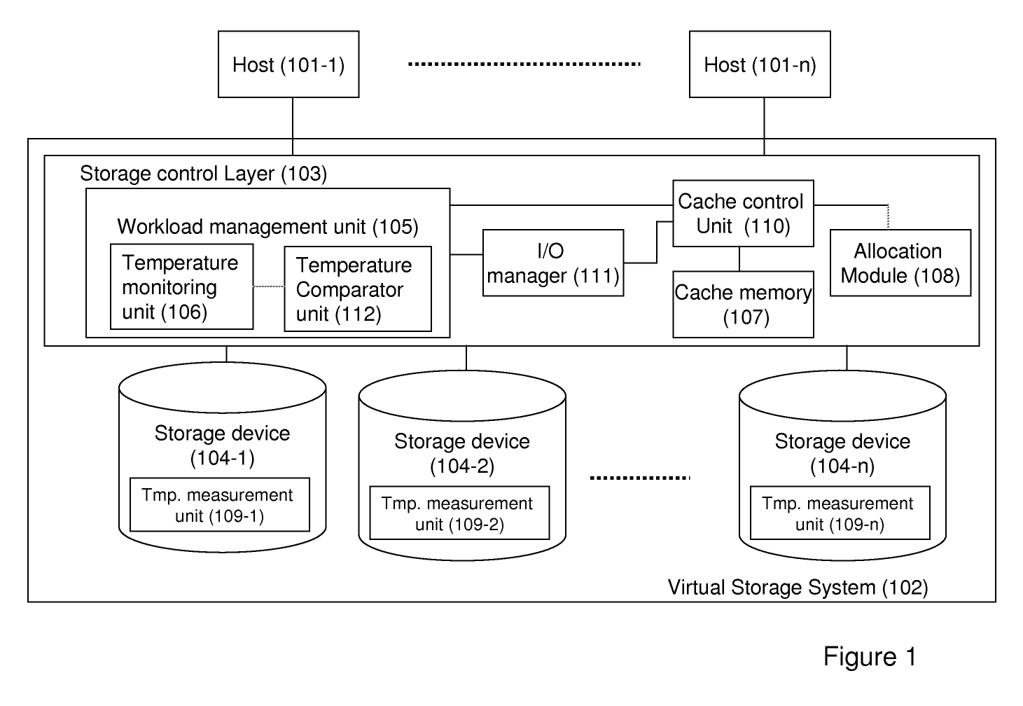

FIG. 1 illustrates a general schematic of the system architecture in accordance with an embodiment of the presently disclosed subject matter. Certain embodiments of the present invention are applicable to the architecture of a computer system described with reference to FIG. 1. However, the invention is not bound by the specific architecture; equivalent and/or modified functionality may be consolidated or divided in another manner and may be implemented in any appropriate combination of software, firmware and hardware. Those versed in the art will readily appreciate that the invention is, likewise, applicable to any computer system and any storage architecture implementing a virtualized storage system. In different embodiments of the invention the functional blocks and/or parts thereof may be placed in a single or in multiple geographical locations (including duplication for high-availability); Control layer 103 in FIG. 1 comprises or is otherwise associated with at least one processor operable for executing operations as described herein. The term “processor” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof. Operative connections between the blocks and/or within the blocks may be implemented directly (e.g. via a bus) or indirectly, including remote connection. Connections between different components in illustrated in FIG. 1, may be provided via Wire-line, Wireless, cable, Internet, Intranet, power, satellite or other networks and/or using any appropriate communication standard, system and/or protocol and variants or evolutions thereof (as, by way of unlimited example, Ethernet, iSCSI, Fiber Channel, etc.).

Bearing this in mind, attention is drawn to FIG. 1 illustrating a general schematic functional block diagram of a virtualized storage system, according to the presently disclosed subject matter. A plurality of host computers (workstations, application servers, etc.) illustrated as 101₁₋ₙ sharing common storage means provided by storage system 102. The storage system comprises a storage control layer 103, operatively coupled to the plurality of host computers, and a plurality of data storage devices 104₁₋ₙ constituting a physical storage space, each storage device comprising one or more disk drives, optionally distributed over one or more nodes in a computer network. Groups of disk drives can be packed in disk units (DUs), also called “disk enclosures”.

The storage control layer 103 is operable, inter alia, to control interface operations (including I/O operations) between hosts 101₁₋ₙ and data storage devices 104₁₋ₙ.

The storage control layer 103 can comprise an Allocation Module 108, a Cache Memory 107 operable as part of the I/O flow in the system, and a Cache Control Unit 110, that regulates data activity in the cache.

Different components of storage control layer 103 can be implemented as centralized modules operatively connected to the plurality of storage devices, or can be distributed over a part or all storage devices.

The storage control layer 103 is further operable to handle a virtual representation of physical storage space and to facilitate necessary mapping between the physical storage space and its virtual representation. Control layer 103 is configured to create and manage at least one virtualization layer interfacing between elements of the computer system (host computers 101₁₋ₙ, etc.) external to the storage system and the physical storage space. The virtualization functions may be provided in hardware, software, firmware or any suitable combination thereof. Optionally, the functions of control layer 103 may be fully or partly integrated with one or more host computers and/or storage devices and/or with one or more communication devices enabling communication between the hosts and the storage devices.

Stored data may be logically represented to a client (host) in terms of logical objects. Depending on the storage protocol, the logical objects may be logical volumes, data files, multimedia files, snapshots and other copies, etc. Typically, definition of logical objects in the storage system involves in-advance configuring an allocation scheme and/or allocation function used to determine the location of the various data portions (and their associated parity portions) across the physical storage medium. The allocation scheme can be handled for example, by an allocation module 108 being a part of the storage control layer 103. The location of various data portions allocated across the physical storage can be recorded and monitored with the help of one or more allocation tables linking between logical data addresses and their corresponding allocated location in the physical storage.

The storage control layer 103 and storage devices 104₁₋ₙ can communicate with host computers 101₁₋ₙ and within the storage system in accordance with any appropriate storage protocol.

In accordance with certain embodiments of the presently disclosed subject matter, storage control layer 103 is further operable to manage workload of storage devices 104₁₋ₙ. To this end control layer 103 can comprise a workload management unit 105 configured, inter alia, to obtain data indicative of a workload of one or more storage devices 104₁₋ₙ and, if needed, enable the modification of distribution of workload across the storage devices based on the obtained data.

According to the teaching disclosed herein, workload management unit 105 is further configured to use temperature measured for one or more disk drives as an indication of workload of the disk drives. In case that temperature measured in respect of a certain disk drive (or a certain group of disk drives) matches a predefined criterion, the workload management unit is configured to enable the modification of workload distribution across the physical storage space in order to reduce the workload on the respective disk drive(s) and to obtain a balanced distribution of the workload across the disk drives in the storage system.

In contrast to known techniques, which utilize the temperatures of disk drives as an indication of a possible hardware failure, workload management unit 105 disclosed herein is configured to use the measured temperature as an indication of the level of disk drive workload. For example, a temperature of a disk drive, which is higher than the temperatures of other disk drives in a storage system, can indicate that the disk is characterized by a greater workload than other disk drives in the system. Moreover, disk drive temperature can be indicative of a general unbalanced distribution of workload across the disk drives in the storage system.

A disk drive, having a measured temperature that matches the predefined criterion, indicates that the workload of the disk drive is irregular. The term “irregular” as used herein in respect of workload, includes for example a disk drive characterized by a workload which is greater than the workload of other disk drives and/or a disk drive which is characterized by a workload which is greater than a normal workload. Under a normal workload, the disk drive typically operates at a normal functioning temperature (e.g. 30° to 33° C.).

Workload management unit 105 can comprise a temperature monitoring unit 106 and a temperature comparator unit 112. Part or all of the storage devices 104₁₋ₙ can comprise a respective temperature measurement unit 109₁₋ₙ configured to provide the temperature of respective disk drives within the storage devices 104₁₋ₙ. A temperature measurement unit 109ᵢ can include a sensor for sensing the temperature of a respective storage device 104ᵢ and an interface configured to provide (in pull and/or in push mode) the measured temperature to workload management unit 105.

Workload management unit 105 can be configured to obtain a current temperature of one or more disk drives within one or more storage devices 104₁₋ₙ. In order to obtain the temperature, workload management unit 105 can utilize temperature monitoring unit 106 which can be configured to obtain the temperature by communicating with temperature measurement units 109₁₋ₙ.

According to certain embodiments, in response to a request received from workload management unit 105, temperature monitoring unit 106 communicates with one or more temperature measurement units 109₁₋ₙ which in turn, measure the temperature of one or more disk drives in storage device 104₁₋ₙ and transmits data indicative of the temperature back to temperature monitoring unit 106.

In some cases, a request to provide temperature measurement, which is issued by workload management unit 105, can include indication of a specific disk drive or a subset of disk drives. In other cases a request can be issued without specification of a disk drive, and temperature measurement can be performed according to a predefined policy, which can be stored for example, in association with workload management unit 105. The policy can specify for example whether the temperature of all or part of the disk drives should be measured. Alternatively, a request to provide temperature measurement of a disk may comply with a default instruction (e.g. to measure all disk drives or the first disk in each enclosure).

Temperature measurements can be initiated (e.g. by workload management unit 105) according to different scheduling policies. For example, temperature measurements can be executed periodically (e.g. every 10 minutes) or they can be executed according to a predefined schedule. Alternatively or additionally, temperature measurements can be performed in response to one or more predefined events (e.g. responsive to a request issued by an administrator).

Different techniques can be used by temperature management unit 106 in order to obtain data indicative of the temperature of the disk drives. For example, in case a SCSI communication protocol is implemented in the storage system, a Temperature Log Page containing temperature-related data can be obtained from the disk drives. A SCSI Log Sense command can be used in order to search the Temperature Log Page and retrieve the data in respect of the temperature of the disk drives. A value returned from a Log Sense command indicates the temperature of a SCSI target device in degrees Celsius at the time the Log Sense command is executed. Further details in respect of Temperature Log Page and Log Sense command are disclosed in Working Project Draft, T10/1731-D Revision 26, 16 Aug. 2010, Information technology-SCSI Primary Commands-4 (SPC-4), Section 7.3.19, which is incorporated herein by reference in its entirety.

Another possible technique for measuring temperature is provided by the SES protocol (SCSI Enclosure Service) in systems using SAS protocol (Serially Attached SCSI). In this case, the sensor measuring the temperature is external to the disk drives, as opposed to internal sensors in the previous examples. Nonetheless, although the relevant commands are optional to these systems, they can be easily incorporated in the protocol. Information on various elements in the enclosures, indicative of status or controls, including temperature of disk drives, is provided by the protocol. Such indicators are, for example, OVERTMP FAIL (over temperature failure) indicating that the power supply has detected a temperature above the safe operating temperature range, or TEMP WARN (over temperature warning), which may warn that the system has increased temperature, leading to possible failure. In certain implementations of SES, vendors add the capability to read temperature of the disk, as part of the SES which may be used in order to obtain data indicative of the temperature of the disk drives.

In some implementations, the SES protocol provides data relating to a single disk drive or an enclosure. Thus, according to a non-limiting example, temperature management unit 106 can be configured to obtain data indicative of the temperature of the disk drive or the temperature of an enclosure, which can be used, e.g. by workload management unit 105, in determining possible modifications of workload distribution among the disk drives.

Further details are disclosed in Working Draft Project, American National Standard T10/2149-D, Revision 01, 22 Jul. 2009, Information technology-SCSI Enclosure Services-3 (SES-3), Sections 6.1.3 and 7.3.4, which is incorporated herein by reference in its entirety.

According to another example, in case a SATA communication protocol is implemented in the storage system, temperature monitoring unit 106 can be configured to obtain temperature measurement of a disk with the help of S.M.A.R.T. (Self-Monitoring, Analysis and Reporting Technology) system. SMART is a monitoring system for computer hard disk drives to detect and report on various indicators of reliability, in order to anticipate failures. One of SMART's attributes is “Temperature Celsius” which provides current internal temperature of a connected device.

Workload management unit 105 can be operable to evaluate the measured temperature of one or more disk drives within storage devices 104₁₋ₙ, in order to determine whether the measured temperature matches a predefined criterion. A measured temperature of a disk drive that matches a certain criterion may be indicative that the disk drive is characterized by workload levels which are irregular. A temperature comparator unit 112, being a part of workload management unit 105, can be operable to compare the data indicative of a measured temperature of one or more disk drives obtained by temperature monitoring unit 106 to a predefined criterion.

For example, the measured temperature can be compared to an absolute temperature threshold value representing a predefined temperature-threshold. Accordingly, the measured temperature matches the predefined criterion, if the measured temperature exceeds the predefined temperature threshold value. The value of the temperature-threshold can be set, for example, as a temperature higher than ordinary functioning temperature of a disk drive and lower than a hazardous temperature that can cause disk malfunction, and also lower than a temperature that would typically trigger an alarm of a potential shutdown of an overheated disk drive. Typically, the normal temperature of a functioning disk drive is between 30 to 33° C. where disk temperature around 60° C. is hazardous to the disk drive and is likely to cause damage. Temperature of 45° C. to 50° C. usually triggers an alarm of a potential shutdown of an overheated disk drive. Accordingly, temperature-threshold value, indicative of irregular disk drive workload, can be set, for example, to 35° C., which is higher than the normal functioning temperature of 30 to 33° C. and lower than the temperature of 45 to 50° C. that triggers an alarm. Other values above 35° C. and below e.g. 50° C. can also be applied. It should be noted that all temperature values indicated herein are non-limiting examples only, and may vary from one system to another.

If workload management unit 105 determines that the measured temperature of a certain disk drive is higher than the temperature-threshold value, workload management unit 105 can be configured to enable modification of distribution of workload across one or more disk drives in storage device 104₁₋ₙ in order to reduce workload on that certain disk drive.

Alternatively or additionally, the measured temperature can be compared to a temperature-threshold value representing the measured temperatures of multiple disk drives in storage system 102. Thus, workload management unit 105 can be configured to evaluate the temperature, by comparing (for example, utilizing temperature comparator unit 112) the measured temperature of a disk to a temperature value representing the measured temperatures of multiple disk drives in storage system 102. Accordingly, the measured temperature matches the predefined criterion, for example, if the measured temperature exceeds the temperature value representing the measured temperatures of multiple disk drives in storage system 102.

The temperature-threshold value can be for example derived from a calculated median or average of temperature values of multiple disk drives. For example, in order to define a temperature threshold value, the average or median of the multiple disk drives can be multiplied by a factor or can be added to a constant value. For example: if the average (or median) of temperature values is 32°, then the threshold can be set to 32*1.1=35.2°, where the factor is 1.1. Another example: if the average (or median) of temperature values is 32°, then the threshold can be set to 32+3=35°, wherein the constant value is 3°. The value representing the measured temperatures of multiple disk drives can, alternatively, be a maximum temperature value from among measured temperatures of multiple disk drives.

Multiple disk drives can include for example all disk drives in storage system 102 or a subset of disk drives. In some cases, the subset can include several disk drives from each of the disk enclosures in the storage system.

In case measured temperature of a disk drive matches the predefined criterion, the disk is designated as a “hot disk drive”, and workload management unit 105 can be configured to enable modification of distribution of workload across the disk drives in one or more storage devices 104₁₋ₙ, in order to reduce workload of the hot disk drive.

Balanced distribution of workload is aimed to more evenly distribute resources utilization of disk drives in system 102. The term “workload” as used herein should be expansively construed to be associated with any kind of operations including I/O operations and control operations performed on the disk drive.

According to the presently disclosed subject matter, the temperature of a disk drive is measured and used as an indication of the workload on the disk drive. In case it is determined, based on the measured temperature, that a certain disk drive is characterized by a workload, which is higher than the workload of other disk drives, the workload distribution can be modified across a plurality of disk drives in order to obtain a more balanced workload across the disk drives.

Redistribution of the workload can be achieved by directing operations to other disk drives (for example, disk drives which show normal temperature), instead of directing the operations to the identified hot disk drive.

Accordingly, workload management unit 105 can be configured to reduce the workload of the hot disk drive by reducing the number of I/O operations which are directed to the hot disk drive. Incoming I/O operations (e.g. initiated by one or more hosts 101₁₋ₙ) can be addressed to other disk drives in system 102 which show normal temperature.

In response to an I/O request, I/O manager 111 can be configured to utilize workload management unit 105 in order to determine which of the disk drives show a normal temperature which is indicative of normal workload, and address the I/O request to one or more of these disk drives.

In some storage systems, allocation of logical volumes to respective physical locations within the disk drives is only performed in response to a write command (named write-out-of-place technique in log form, also known as “log-write”). Such an allocation scheme may be applied both in case new data is being written, and when a write-request relates to modification of existing data. A non-limiting example of the write-out-of-place technique is the known write-anywhere technique, enabling writing data blocks to any available disk drive without prior allocation.

According to one example, in response to a write-request from a host 101₁₋ₙ, I/O manager 111 can be configured to obtain information indicative of the disk drives that are characterized by excessive workload, and direct the write operation to one or more other disk drives that are characterized by normal workload. Information in respect of disk drives having high or regular level of workload can be obtained by I/O manager 111 from workload management unit 105 (by a pull type operation). Alternatively or additional, workload management unit 105 can be configured to provide this information (by a push type operation) to I/O manager 111. According to the teaching disclosed herein the information obtained by workload management unit 105 can e.g. be based on the measured temperature, as described above.

Furthermore, according to log-write allocation technique, a modified data block is written to a new physical location in the storage space (e.g. on a different disk drive). Thus, when data is modified after being read to memory from a location on a disk drive, the modified data can be written to a new physical location so that the previous, unmodified version of the data is retained, while the reference to it is typically deleted, the storage space at that location therefore becoming free for reuse.

Accordingly, in case log-write allocation technique is being implemented in system 102, a write-request, which is directed to modify data already existing on a hot disk, can be redirected to a different physical address, not necessarily located on the disk drive storing the original data. For example, responsive to a write request, I/O manager 111 can be configured to allocate the data to a disk drive characterized by normal workload based on relevant information which is received from workload management unit 105, as explained above.

Furthermore, in some cases, in response to a read-request, if the requested data is located on a disk drive which has been identified as a hot disk drive and a copy of the data is stored in storage system 102 in an additional location on a different disk drive which was not identified as a hot disk drive, the data can be read from the alternative location instead of the hot disk drive.

For example, storage control layer 103 can be configured to facilitate various protection schemes such as Redundant Array of Independent Disks (RAID), which can be employed to protect data from internal component failures by making copies of data and rebuilding lost or damaged data. Different RAID schemes implement different protection schemes. For example, RAID 1 implements mirroring without parity and RAID 5 and 6 implement one and two parity portions, respectively. According to the presently disclosed subject matter, by way of example, in a case system 102 implements a RAID protection scheme, and a read request is directed to a disk drive characterized by high workload (e.g. identified as a hot disk by workload management unit 105), I/O manager can retrieve the requested data from a minor copy or obtain the data based on the respective parity portions, and avoid accessing the hot disk drive.

In some cases, workload management unit 105 can consider the temperature of the identified hot disk drive and select a suitable action for reducing workload of the identified disk accordingly. In one non-limiting example, in case the temperature of an identified hot disk is lower than a second predefined threshold, which is higher than the first predefined threshold used for identifying a hot disk-drive, yet lower than a temperature that would typically trigger an alarm of a potential shutdown of an overheated disk drive, workload management unit 105 is configured to instruct I/O manager 111 to selectively restrict the I/O operations directed to that disk drive. According to one non-limiting example, such selective restriction includes directing write requests to other disk drives, while continuing to address read-requests to the hot disk drive. Only if the temperature of the hot disk rises above the second predefined threshold, read-requests are executed with the help of RAID parity portions, which involve more complex data retrieval and processing.

Popular data, which is frequently accessed data, contributes to the overload of the disk drive. Unpopular data is accessed less frequently than popular data, thus the lower number of I/O operations associated with unpopular data contributes to a reduced workload of the disk drive. Therefore, workload management unit 105 can be operable to redistribute the data in the disk drives according to their popularity. More specifically, workload management unit 105 can be configured to migrate popular data from a hot disk drive to other disk drives showing regular temperature. Since unpopular data is accessed less frequently, as a result, the number of I/O operations to the hot disk drive will decrease. According to a non-limiting example, migration of popular data can be an ongoing background process, which includes, moving popular data sections from the hot disk drive to one or more other disk drives which are not identified as hot disk drives, and/or upon receipt of a write-request of data that is destined to the hot disk drive, writing the data to one or more other disk drives not identified as hot.

Due to the dynamic nature of storage systems, the temperature of disk drives may vary over time. Consequently, workload management unit 105 can be configured to continuously monitor the temperature of disk drives in storage system 102 and update the status of the disk drive accordingly.

Workload management unit 105 can be configured to utilize a data-repository (not shown) for storing the last measured temperatures of each measured disk drive. Workload management unit 105 can update the data repository upon receiving data indicative of measured temperatures. Workload management unit 105 can determine a period of time in which the measured temperatures are valid. According to a non-limiting example, the temperatures may be valid for a period of a few minutes, at the end of which a new measurement must be taken, in order to obtain the temperature of a disk drive.

The measured results stored in the data repository may be used, for example, by workload management unit 105, when forming the criterion. For example, the value representing the criterion for determining a hot disk may be set based on the measured temperature of the disk drives stored in the data repository.

In addition, the measured temperatures stored in the data repository can be used (e.g., by I/O manager 111) for identifying disk drives which are not hot, in order to determine the new destination of I/O operations originally directed to an identified hot disk drive.

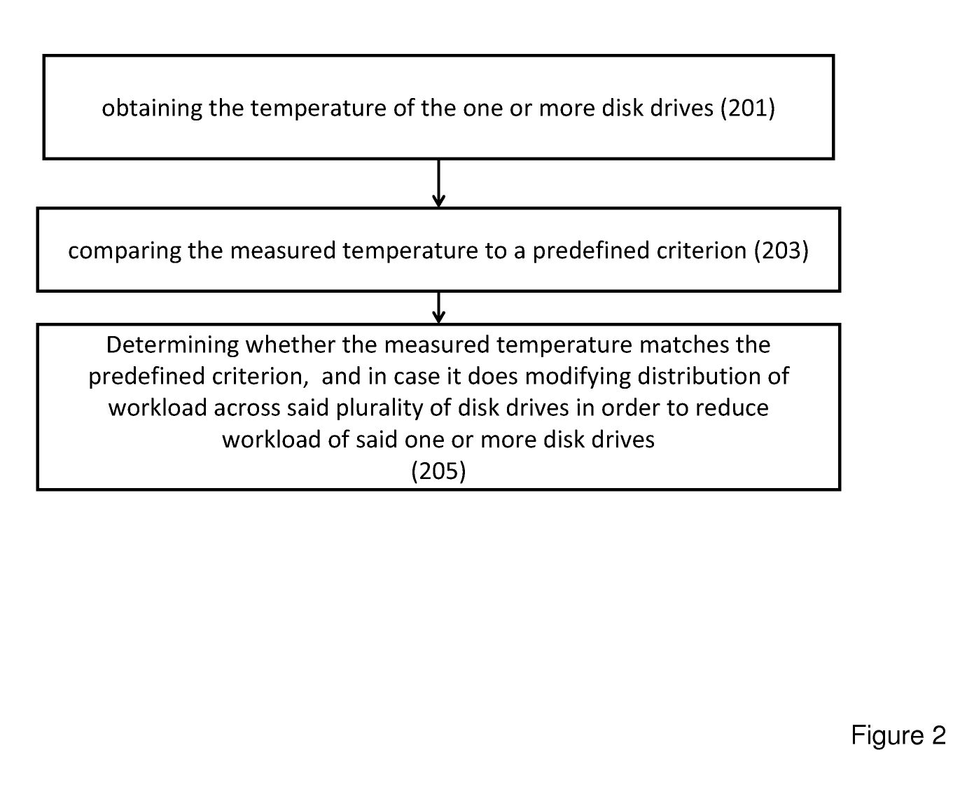

FIG. 2 is a flowchart illustrating operations which are performed, in accordance with the presently disclosed subject matter.

As illustrative in block 201 of FIG. 2, the temperature of one or more disk drives is measured. As explained above, this is done as a part of a process aimed at monitoring the workload of one or more disk drives. The operations which are described with reference to FIG. 2 can be performed, for example by control layer 103, utilizing workload management unit 105.

Once a temperature of at least one disk drive is obtained, the value of the measured temperature can be compared to a predefined criterion (block 203). Comparing the temperature can be made, for example, by temperature comparator unit 112. If the measured result matches the predefined criterion, modification of distribution of workload across the plurality of disk drives, in order to reduce workload of the one or more disk drives (block 205), is enabled.

As stated earlier, a disk drive, having a measured temperature that matches the predefined criterion, indicates that the workload of the disk drive is irregular, including for example a disk drive characterized by a workload which is greater than the workload of other disk drives and/or a disk drive which is characterized by a workload which is greater than a normal workload. As mentioned above, redistribution of the workload can be achieved through a number of methods, for example, by re-directing I/O operations sent to the identified hot disk drive to other disk drives showing normal temperature. Thus, according to an example, in response to receiving a read-request addressed to an identified hot disk drive, data is obtained from another disk drive showing normal temperature. According to yet another example, a write-request of new data is directed to a disk drive which was not identified as hot. In case the write-request includes modifications to existing data on an identified hot disk drive, the modified data can be written in another disk drive, which is not hot, as illustrated above with respect to log-write technique.

According to yet another example, redistribution of the workload can be also be achieved by migrating data, according to their popularity, from a disk drive identified as a hot disk to other disk drives in storage system 102.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A storage system comprising a storage control layer operatively coupled to a plurality of disk drives, said storage control layer comprising at least one processor operable:
to receive data indicative of a temperature of at least one disk drive among said plurality of disk drives, wherein said temperature is indicative of workload of said at least one disk drive; and
responsive to receiving a temperature matching a predefined criterion, to enable modification of workload distribution across said plurality of disk drives in order to reduce a workload of said at least one disk drive.

2. The storage system of claim 1, wherein said storage control layer is further operable to determine whether said data indicative of a temperature, matches said predefined criterion; wherein a temperature that matches said predefined criterion indicates that the workload of the disk drive is irregular.

3. The storage system of claim 1, wherein said control layer is configured to facilitate said modification by migrating popular data from said at least one disk drive to at least one other disk drive, said at least one other disk drive having a temperature not matching said predefined criterion.

4. The storage system of claim 1, wherein said control layer is further configured to facilitate said modification by directing a read-request in respect of a first data located on said at least one disk drive to at least one other disk drive, said at least one other disk drive having a temperature not matching said predefined criterion and containing a second data which is sufficient for obtaining said first data.

5. The storage system of claim 4, wherein said first data and said second data are identical.

6. The storage system of claim 4, wherein said second data is obtained by applying a parity calculation to other data portions of a RAID stripe associated with the first data, wherein the other data portions reside on disk drives having a temperature not matching said predefined criterion.

7. The storage system of claim 1, wherein said control layer is further configured to facilitate said modification by redirecting a write-request to at least one other disk drive, said at least one other disk drive having a temperature not matching said predefined criterion.

8. The storage system of claim 1, wherein said predefined criterion is selected from a group consisting of a predefined temperature threshold value, and a temperature value representing the measured temperatures of one or more disk drives.

9. The storage system of claim 8, wherein said temperature value can be derived from a group consisting of:
a calculated median or variation thereof of measured temperatures of multiple disk drives;
an average or variation thereof of measured temperatures of multiple disk drives; and
a maximum of measured temperatures of multiple disk drives.

10. The storage system of claim 1, wherein said storage control layer further comprises a temperature monitoring unit, and wherein said at least one disk drive comprises a temperature measurement unit, said temperature monitoring unit is configured to communicate with said temperature measurement unit in order to receive said data indicative of a temperature of said at least one disk drive.

11. The storage system of claim 1, wherein said storage control layer further comprises a temperature comparator unit configured to define whether said received data indicative of a temperature matches said predefined criterion.

12. A method of managing a plurality of disk drives in a storage system, the method comprising:
monitoring a workload of at least one disk drive among said plurality of disk drives, wherein the monitoring comprises receiving data indicative of a temperature of said at least one disk drive; and
responsive to matching said temperature to a predefined criterion, enabling modification of workload distribution across said plurality of disk drives in order to reduce workload of said at least one disk drive.

13. The method of claim 12, wherein said monitoring further comprises determining whether said data indicative of a temperature, matches said predefined criterion.

14. The method of claim 12, wherein said enabling comprises migrating popular data from said at least one disk drive to at least one other disk drive, having temperature not matching said predefined criterion.

15. The method of claim 12, wherein said enabling comprises directing a read-request in respect of a first data located on said at least one disk drive to at least one other disk drive, having temperature not matching said predefined criterion and containing a second data which is sufficient for obtaining said first data.

16. The method of claim 15, wherein said first data and said second data are identical.

17. The method of claim 12, wherein said enabling comprises redirecting a write-request to at least one other disk drive, having temperature not matching said predefined criterion.

18. The method of claim 12, wherein said predefined criterion is selected from a group consisting of a predefined threshold value, and a temperature value representing the measured temperatures of one or more disk drives.

19. The method of claim 18, wherein said temperature value can be derived from a group consisting of:
a calculated median or variation thereof of measured temperatures of multiple disk drives;
an average or variation thereof of measured temperatures of multiple disk drives; and
a maximum of measured temperatures of multiple disk drives.

20. The method of claim 12, further comprising communicating with said at least one disk drive in order to obtain said data indicative of a temperature of said at least one disk drive, in order to facilitate said matching.

21. A program storage device readable by machine, tangibly embodying a program of instructions executable by the machine to perform a method of managing a plurality of disk drives in a storage system, the method comprising:
monitoring a workload of at least one disk drive among said plurality of disk drives, wherein monitoring comprises obtaining data indicative of a temperature of said at least one disk drive;
to determining whether said data indicative of a temperature, matches said predefined criterion; and
responsive to matching said temperature to a predefined criterion, enabling modification of workload distribution across said plurality of disk drives in order to reduce workload of said at least one disk drive.

22. A workload management unit operatively connected to a storage control layer comprising at least one processor in a storage system, the control layer being operatively coupled to a plurality of disk drives, workload management unit operable:
to receive data indicative of a temperature of at least one disk drive among said plurality of disk drives, wherein said temperature is indicative of workload of said at least one disk drive; and
responsive to the receiving a temperature matching a predefined criterion, to enable modification of workload distribution across said plurality of disk drives in order to reduce workload of said at least one disk drive.
